(19) United States
(12) Patent Application Publication
(10) Pub. No.: US 2006/0141186 A1
(43) Pub. Date: Jun. 29, 2006

(54) Gloves with hydrogel coating for damp hand donning and method of making same

(76) Inventors: Robert Allen Janssen, Alpharetta, GA (US); Kermit R. Littleton, Ellijay, GA (US); Shantilal Hirji Modha, Alpharetta, GA (US); Kwok Wing Fung, Easley, SC (US); Robert Arthur Beauvais, Fountain Inn, SC (US); Myung Eok Hyun, Greenville, SC (US)

Correspondence Address: KIMBERLY-CLARK WORLDWIDE, INC., 401 NORTH LAKE STREET, NEENAH, WI, 54956, US

(21) Appl. No.: 11/023,743

(22) Filed: Dec. 28, 2004

(51) Int. Cl. B32B 27/08; B32B 27/30

(52) U.S. Cl. 428/35.7; 428/522; 428/521; 428/519; 428/520

(57) ABSTRACT

Disclosed herein is an elastomeric article having a hydrogel donning coating. The hydrogel donning coating is made of a copolymer of hydroxy ethyl acrylate (HEA), hydroxy ethyl methacrylate (HEMA), and acrylic acid. The hydrogel donning coating is applied to the elastomeric article using an aqueous hydrogel dipping solution containing the hydrogel donning coating copolymer. The aqueous hydrogel dipping solution demonstrates thixotropic characteristics which allows for better manufacturing process control.

### BACKGROUND

Tightly fitting elastomeric articles, such as surgical and examination gloves may be difficult to don due to undue clinging or friction between the surface of the article and that of the skin of the wearer. The problem of donning becomes greater when the skin of the wearer is damp. This is primarily the case with surgical gloves where the surgeon prepares his hands prior to insertion into the glove by scrubbing them and, as often is the case, performing only a fast, incomplete drying. Once partially dried, the surgeon will usually wave the hands to evaporate additional moisture, put on a surgical gown and then don the gloves with assistance.

Natural latex gloves are tacky and have a high coefficient of friction. This does not allow for the easy introduction of a hand into the glove. This difficulty in donning becomes a greater issue when the hands are damp or wet. Therefore, some sort of surface treatment is required on the inner surface of the glove to facilitate donning.

Traditionally, powdered lubricants have been applied to the inside surface of the glove to reduce friction between the skin and the glove. Unfortunately, the use of powdered lubricants may not be appropriate for specific situations, such as the case of surgical gloves. Specifically, if some of the powder escapes from the inside of the glove into the surgical environment, as for example if the glove is torn during the surgery, the powder may enter the surgical wound and cause further complications for the patient.

As a further solution to the problem, polymeric lubricant coatings have been developed to modify the interior surface of the gloves in an effort to provide safe and effective donning for medical practitioners. The surface modification coating that has had the best success to date and that is most accepted is a hydrogel polymeric coating.

Such a hydrogel polymeric coating requires crosslinking of the hydrogel polymer to both attach the polymeric coating to the natural latex of the glove, such that the coating does not separate from the latex when the glove is stretched, and to prevent the hydrophilic hydrogel polymer from dissolving upon rehydration during subsequent processing during manufacture.

Another issue in the application of a coating to a glove is achieving a uniform coating on the surface of the glove without streaking. Visible streaking of the coating occurs when the polymer continues to flow over the glove as it is removed from the coating bath.

It is desired that to produce a hydrogel polymeric coating on an elastomeric article that does not separate from the article when the article is stretched and does not dissolve upon rehydration. It is also desired that a coating dip solution be formulated such that the amount of coating applied to an article upon dipping could be controlled and provide the article with an even coating without streaks.

### SUMMARY OF THE INVENTION

The present invention is directed to an elastomeric article with a hydrogel donning coating made up of hydroxy ethyl acrylate (HEA), hydroxylethyl methacrylate (HEMA) and acrylic acid (AA). In one embodiment the hydrogel donning coating contains less than about 65 mole percent of hydroxylethyl acrylate. The hydrogel donning coating in one embodiment has between about 44 and about 64 mole percent HEA, between about 20 and about 40 mole percent HEMA, and about 6 and about 36 mole percent M. In another embodiment, the hydrogel donning coating has between about 49 and about 59 mole percent HEA, between about 25 and about 35 mole percent HEMA, and about 6 and about 26 mole percent M. In another embodiment, the hydrogel donning coating has between about 53 and about 55 mole percent HEA, between about 29 and about 31 mole percent HEMA, and about 14 and about 16 mole percent M.

The hydrogel donning coating is applied to the substrate body of the elastomeric article. In various embodiments, the substrate body can be made of a natural rubber, nitrile butadiene rubber, and styrene-ethylene-butylene-styrene block copolymer. In further embodiments, the substrate body can be made of styrene-isoprene-styrene block copolymer, styrene-butadiene-styrene block copolymer, styrene-isoprene block copolymer, styrene-butadiene block copolymer, synthetic isoprene, chloroprene rubber, polyvinyl chloride, silicone rubber, and combinations of such block copolymers.

Additionally, in one embodiment a lubricant layer can be applied to the hydrogel donning coating.

The invention is also directed to a method of making an elastomeric article with a hydrogel donning coating, such as described above. The hydrogel donning coating is applied to the elastomeric article by immersion in an aqueous solution of hydrogel polymer, where the solution demonstrates thixotropic properties.

### BRIEF DESCRIPTION OF THE DRAWINGS

FIG. 1 is a perspective view of an elastomeric article, namely a glove, which may be formed according to the present invention;

FIG. 2 is a schematic cross-sectional illustration of the article of FIG. 1 taken along a line 4-4, the article including a substrate body and a donning layer; and

FIG. 3 is another schematic cross-sectional illustration of the article of FIG. 1 taken along a line 4-4, the article including a substrate body, a donning layer, and a lubricant.

### DETAILED DESCRIPTION

In general, the present invention is directed to an elastomeric article, such as a condom or glove, which contains a hydrogel coating. As used herein, the term “elastomeric article” refers to an article formed predominantly from an elastomeric polymer. As used herein, the term “elastomeric polymer” refers to a polymeric material that is capable of being easily stretched or expanded, and will substantially return to its previous shape upon release of the stretching or expanding force. The inventors have discovered a hydrogel coating capable of improving donning (damp and/or dry) and improving the manufacturing process of such coated articles. While this invention pertains to polymeric coatings for all rubber articles, it will focus on gloves, which are the most complex of rubber articles in terms of use and manufacture.

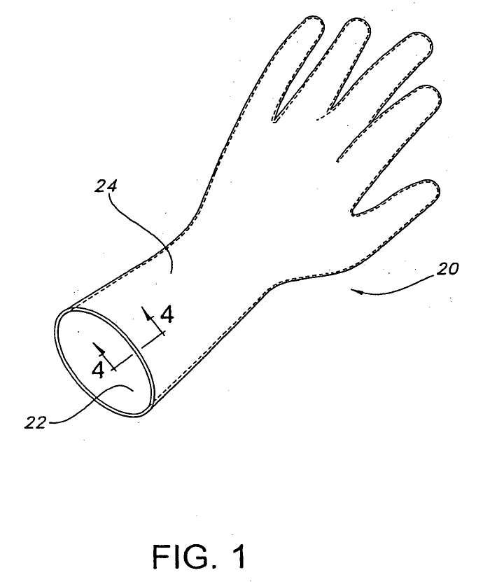

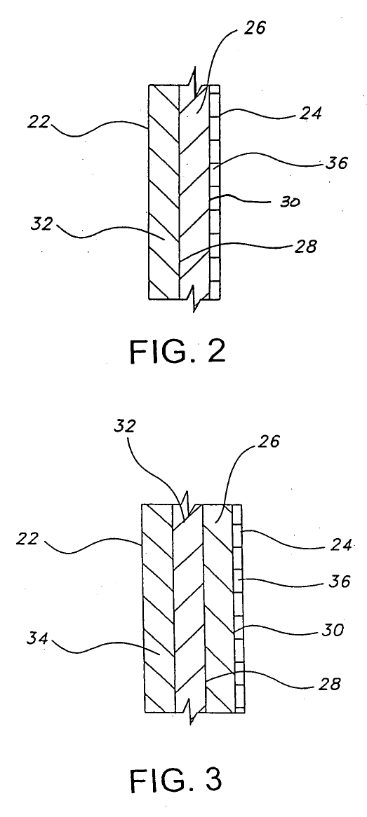

An article made according to the present invention, for example, a glove 20, generally includes an inside surface 22 and an outside surface 24 (FIG. 1). As used herein, the “inside surface” refers to the surface of the article that contacts the body of the wearer. As used herein, the “outside surface” refers to the surface of the article that is distal from the body of the wearer. The glove includes a substrate body 26 having a first surface 28 and a second surface 30 (FIGS. 2-3). As used herein, “first surface” refers to the surface of the substrate body proximal to the body of the wearer. As used herein, “second surface” refers to the surface of the substrate body distal to the body of the wearer.

The article of the present invention may include a single layer or multiple layers as desired. In a single layer glove including only the substrate body, the first surface may form the inside surface of the glove. However, in a multi-layer glove having additional layers proximal the body of the wearer, the additional layer or layers may each form a portion of the inside surface, or the entire inside surface, as desired. Likewise, in a single layer glove including only the substrate body, the second surface may form the outside surface of the glove. However, in a multi-layer glove having additional layers distal from the body of the wearer, the additional layer or layers may each form a portion of the outside surface, or the entire outside surface, as desired.

For example, as depicted in FIG. 2, the article may include a donning layer 32 overlying at least a portion of the first surface 28 of the substrate body 26. In such an article, the donning layer 32 forms at least a portion of the inside surface 22 of the glove 20. As depicted in FIG. 3, the article may also include other layers, such as a lubricant layer 34 that overlies at least a portion of the donning layer 32. In such an article, the lubricant layer 34 forms at least a portion of the inside surface 22 of the glove 20.

An elastomeric article of the present invention may be formed using a variety of processes, for example, dipping, spraying, drying, and curing. An exemplary dipping process for forming a glove 20 is described herein, though other processes may be employed to form various articles having different shapes and characteristics. Although a batch process is described and shown herein, it should be understood that semi-batch and continuous processes may also be utilized with the present invention.

A glove 20 (FIG. 1) is formed on a hand-shaped mold, termed a “former”. The former may be made from any suitable material, such as ceramic, glass, metal, porcelain, or the like.

The surface of the former defines at least a portion of the surface of the glove 20 to be manufactured.

If desired, a former may be cleaned prior to formation of a glove 20 on the former. The cleaning process may generally include an optional water pre-rinse followed by an acid wash. After the acid wash, the former may be rinsed with water and dipped in a heated caustic solution prior to a final water rinse. After the cleaning process, a glove may be formed on the former through a series of dipping and drying steps.

After cleaning, the former may be dipped into a coagulant composition prior to forming the main body of the glove 20 on the former. A coagulant causes the base latex polymer that forms the main body of the glove 20 to coagulate. Coagulants that may be used in the present invention may include powders (e.g., calcium carbonate), to ease removal of the glove from the former, or, if desired, may be powder free coagulant compositions. For example, a powder free coagulant composition may be used which includes water soluble salts of calcium, zinc, aluminum, and the like. Optionally, the coagulant composition may contain additives such as surfactants. A surfactant may provide enhanced wetting to avoid forming a meniscus which can trap air between the form and deposited elastomeric polymer, particularly in the cuff area. However, any suitable coagulant composition may be used, including those described in U.S. Pat. No. 4,310,928 to Joung, incorporated herein in its entirety by reference.

The coated former is then dipped into a polymer composition containing an elastomeric polymer to form the substrate body 26 (FIGS. 1, 2, and 3). The substrate body 26 may be formed from any suitable elastomeric polymer, and in some embodiments, the substrate body 26 may be formed from natural rubber, which is typically provided as a compounded natural rubber latex. In other embodiments, the elastomeric polymer may include nitrile butadiene rubber, and in particular, may include carboxylated nitrile butadiene rubber. In yet other embodiments, the elastomeric polymer may include synthetic isoprene. Styrene-isoprene-styrene (S-I-S) block copolymers, styrene-polybutadiene block copolymers (S-B), styrene-polybutadiene-styrene (S-B-S) block copolymers, styrene-ethylene-butylene-styrene block copolymers, and mixtures thereof can form the basis for the substrate body 26. While articles formed from natural rubber are described in detail herein, it should be understood that any other suitable polymer or combination of polymers may be used with the present invention.

Thus, the polymer composition may contain various components, for example, compounded natural rubber latex, stabilizers, antioxidants, curing activators, organic accelerators, vulcanizers, and the like. The stabilizers may include phosphate-type surfactants. The antioxidants may be phenolic, for example, 2,2′-methylenebis (4-methyl-6-t-butylphenol). The curing activator may be zinc oxide. The organic accelerator may be dithiocarbamate. The vulcanizer may be sulfur or a sulfur-containing compound. To avoid crumb formation, the stabilizer, antioxidant, activator, accelerator, and vulcanizer may first be dispersed into water by using a ball mill and then combined with the natural rubber latex.

During the dipping process, the coagulant on the former causes some of the elastomer to become locally unstable and coagulate onto the surface of the former. The elastomer coalesces, capturing the particles present in the coagulant composition at the surface of the coagulating elastomer. The former is withdrawn from the bath of elastomer and the coagulated layer is permitted to fully coalesce, thereby forming a substrate body 26. The former is dipped into one or more latex baths a sufficient number of times to attain the desired glove 20 thickness. In some embodiments, the substrate body 26 may have a thickness of from about 0.004 inches to about 0.012 inches.

The former is then dipped into a leaching tank in which hot water is circulated to remove the water-soluble components, such as residual calcium nitrates and proteins contained in the natural rubber latex. This leaching process may generally continue for about twelve minutes at a water temperature of about 120° F. The glove 20 is then dried on the former to solidify and stabilize the substrate body 26. It should be understood that various conditions, process, and materials may be used to form the substrate body 26. Furthermore, other layers may be formed by including additional dipping processes. Such layers may be used to impart additional attributes to the glove 20.

When desired, the former may then be dipped into a composition to form a donning layer 32 over at least a portion of the first surface 28 of the substrate body 26 to facilitate donning of the glove 20 (FIGS. 1, 2, 3). The composition used in the present invention is an aqueous hydrogel polymeric solution. As used herein, the term “hydrogel” refers to a polymeric material that is capable of absorbing more than 20 percent its weight in water while maintaining a distinct three-dimensional molecular structure. The aqueous hydrogel solution contains the hydrogel polymer that forms the donning layer 32, a crosslinking agent, a crosslinking activator, a processing aid and water.

The use of a hydrogel polymer as a donning layer of an elastomeric article aids in donning in two ways. First, the hydrogel polymer coating aids in damp hand donning of the gloves due to its ability to absorb moisture. This same absorbent characteristic reduces the moisture in the glove during wear. Secondly, the hydrogel coating can aid in donning by providing a donning layer with a “hard” surface. Such a “hard” surface will present a surface with a lower coefficient of friction, which in the case of a glove, will make it easier for the hand of the wearer to slide across. A “hard” surface may be produced by selecting the donning layer polymer based on its glass transition temperature. The “glass transition temperature” is the temperature at which an amorphous material changes from a brittle, vitreous state to a plastic state. To have a “hard” surface, it would be desired to have a donning layer polymer that has more of a glassy character (i.e., hard, brittle) than a non-glassy character (i.e., soft, plastic, pliable). Such a glassy character may be obtained by selecting a donning layer polymer with a glass transition temperature above the ambient temperature range of the environment in which the elastomeric article will be used. For example, a donning layer polymer having a glass transition temperature above 50 degrees Celsius will remain “hard”, or glassy, as long as the ambient temperature of use remains below 50 degrees Celsius. By having a more glassy character, the polymer coating will be harder rather than softer and tackier, at ambient temperatures.

These desired properties have been demonstrated by the inventors with a hydrogel copolymer that includes hydroxy ethyl acrylate (HEA), hydroxy ethyl methacrylate (HEMA), and acrylic acid (AA). The acrylic acid acts as a compatilizer for the HEA and HEMA, and allows them remain soluble in an aqueous dipping solution at concentrations of HEA not previously demonstrated for hydrogel copolymers containing HEA and HEMA. In particular, a hydrogel copolymer having a HEA concentration of less than 65 mole percent can be produced for use in an aqueous dipping solution. Lowering the concentration of HEA in the hydrogel polymer increases the glass transition temperature of the hydrogel polymer, thus providing a harder surface to the donning layer. In general, the copolymer of the invention comprises approximately about 44 to about 64 mole percent HEA, about 20 to about 40 mole percent HEMA, and about 6 to about 36 mole percent acrylic acid. Desirably, the composition comprises approximately about 49 to about 59 mole percent HEA, about 25 to about 35 mole percent HEMA, and about 6 to about 26 mole percent acrylic acid. Desirably, the composition comprises approximately about 53 to about 55 mole percent HEA, about 29 to about 31 mole percent HEMA, and about 14 to about 18 mole percent acrylic acid.

It is also desired that the aqueous hydrogel dipping solution exhibit controllable rheological characteristics. Control of the rheology of the dipping solution provides a significant processing aid. By controlling the parameters that affect the rheology of the dipping solution, the amount of coating applied to the glove can be adjusted and the coating can be more evenly distributed about the surface of the glove. These desired properties have been demonstrated by the inventors with the hydrogel copolymer, as previously discussed, in a hydrogel dipping solution which also includes polyacrylic acid as a processing aid, a crosslinking agent, a crosslinking activator, such as para-toluene sulfonic acid, and water. This inventive hydrogel aqueous solution has been found to provide the desired rheological control with two controllable characteristics: the solution has (1) thixotropic characteristics and (2) a viscosity that can be altered by changing the pH of the solution.

As used herein, “thixotropic” or “shear thinning” characteristics refer to a solution that exhibits increased viscosity at decreasing rates of shear and exhibits decreased viscosity at increasing rates of shear. The ability of the dipping solution to exhibit this type of behavior is a significant processing aid.

The former, containing the hydrogel coated glove, experiences shear forces at the interface of the glove (contained on the former) and any solution which it contacts during the multiple dipping steps of the production process. Such shear forces occur at the glove-solution interface as the former is immersed and removed from a dipping tank, pulled through a tank in an immersed position, rotated in a tank while immersed, or any combination of such movements. Additionally, to some degree, shear forces are imparted to the dipping tank solution through the agitation of the tank solution itself.

While the former containing the hydrogel coated glove is being moved through or removed from the dip tank, the coating solution at the glove-solution interface will have a certain viscosity based the shear forces present at the glove-solution interface. At the instant of removal from the dip tank, the shear forces present at this interface with drop from some finite value to zero. Thus, when the glove is removed from the dip tank, the viscosity of the coating will increase because the shear forces present at the glove-solution interface have been removed. With an increase in viscosity, the coating will cease to flow over the glove and thus will prevent the formation of “streak marks” on the glove. Additionally, the coating will be uniformly distributed over the surface of the glove.

A solution having a known thixotropic response, will allow the coating of the glove to be controlled as desired. The coating can be controlled through the rate that the former enters and exits the dipping tank, commonly known as the “exit rate.” This exit rate is related to the shear forces that will be present at the glove-solution interface. The viscosity of the solution can also be influenced by the shear that is induced in the dipping tank through agitation. By controlling these known parameters, an improved uniform distribution of coating can be achieved will minimal, if any, streaking of coating polymer. The amount of coating can similarly be controlled.

The polyacrylic acid acts as a processing aid in producing such a thixotropic response in the hydrogel solution. While the inventors are not limited to a single theory of operation, it is generally thought that the polyacrylic acid provides the thixotropic response through its structure and through its ability to form hydrogen bonds.

The polyacrylic acid used in the hydrogel solution is partially crosslinked to give it a highly branched structure. In the present invention, such a structure provides for the non-newtonian response observed when used in the hydrogel solution (i.e., the viscosity of the solution is dependent on the shear forces). For example, such a structure can be found in commercially available rheology modifiers described for use in the present invention and may be characterized as homopolymers of acrylic acid that are crosslinked with allyl sucrose or allyl pentaerythritol. Exemplary materials of this type are sold by Noveon, Inc., Cleveland, Ohio, USA, under the trade designation CARBOPOL® Rheology Modifiers. A specific example of such a partially crosslinked polyacrylic acid available from Noveon, Inc. is CARBOPOL® 980. More information regarding the nomenclature and chemistry of such rheology modifiers is available in the technical bulletin, “Noveon—Pharmaceutical Polymers Technical Bulletin 3: Nomenclature and Chemistry” (January 2002), from Noveon, Inc., Cleveland, Ohio, USA.

In contrast, polyacrylic acids that are not crosslinked are generally thought to exhibit newtonian flow when used as rheology modifiers (i.e., the viscosity is independent of shear forces). For example, use of a non-crosslinked polyacrylic acid, such as an alkali swellable emulsion rheology modifier designed for printing applications, does not produce the desired thixotropic response when used in the hydrogel solution. One such polyacrylic acid that was found to not provide the desired rheological response in the present invention was ACRYSOL® ASE-95, available from Rhom & Hass Co.

Additionally, the polyacrylic acid acts as a processing aid in its ability to form secondary chemical crosslinks through hydrogen bonding with itself and the components of is the hydrogel polymer. The ability to form such electrostatic bonds allows the polyacrylic acid to keep the hydrogel solution well blended.

It has also been found that the viscosity of the hydrogel solution can be controlled through control of the pH of the solution. The polyacrylic acid of the coating solution contains carboxyl acid groups which are capable of ionizing in a water solution. The increase in ionization of carboxyl acid groups, results in an increase of viscosity of the solution. Thus by controlling the pH of the dipping solution, through addition of a dilute solution of sodium hydroxide, the viscosity of the solution can be modified.

The viscosity response of the hydrogel solution can be determined empirically. The viscosity of the inventive hydrogel solution can be measured as function of pH and as a function of exit rate. Such empirical observations can provide a correlation of viscosity as a function of pH and exit rate. With such a correlation, the amount of coating of applied to the former by dipping in the known hydrogel solution can be known and controlled by altering the exit rate and/or the pH of the solution.

The crosslinking agent of the hydrogel solution crosslinks the hydrogel polymers into cohesive hydrogel coating and secondarily bonds the hydrogel coating to the surface of the substrate body 26. In selecting the proper crosslinking agent for the hydrogel donning layer it is noted that the hydrogel polymer includes both hydroxyl and carboxyl functionality. Additionally, it is desired that the crosslinking agent aids in crosslinking the hydrogel coating with the amide groups present in the proteins of natural latex of the substrate body 26. This results in a hydrogel coating that is cohesively strong, that will not redissolve in water, and that will not separate from the substrate body 26. Such undesired separation of the coating is often referred to as “flaking off” of the coating.

Two examples of such crosslinking agents are the melamine-formaldehyde crosslinking agents available from Cytec Industries Inc., West Patterson, N.J., USA, and sold under the trade designations, CYMEL® 385 and CYMEL® 373. The crosslinking reaction using the CYMEL® crosslinking agents is through the chemistries of amide, hydroxyl, and carboxyl containing polymers. The CYMEL® crosslinking agents also contain formaldehyde as one of its reactants to crosslink with the functional groups of the hydrogel polymers. While both CYMEL® crosslinking agent chemistries produce adequate results, the CYMEL® 385 produces a harder cured film than the CYMEL® 373, which produces a coating that is slightly easier to remove from the formers and theoretically should produce a lower coefficient of friction surface.

Once coated, the former is sent to a curing station (e.g., oven) where the natural rubber is vulcanized and the hydrogel-forming polymer is crosslinked. If desired, the curing station may initially evaporate any remaining water and then proceed to the higher temperature vulcanization and crosslinking steps. For instance, curing of the hydrogel-forming polymer may be initiated by heating at a temperature from about 25° C. to about 200° C., in some embodiments from about 50° C. to about 150° C., and in some embodiments from about 70° C. to about 120° C., for a period of time of from about 1 minute to about 12 hours, in some embodiments from about 5 minutes to about 5 hours, and in some embodiments, from about 10 minutes to about 1 hour. Vulcanization may occur at the same time as the crosslinking of the hydrogel-forming polymer, or at a different time. If desired, the oven may be divided into four different zones with a former being conveyed through the zones of increasing temperature. One example is an oven having four zones with the first two zones being dedicated to drying, and the second two zones being primarily to vulcanization and crosslinking of the hydrogel polymer. Each of the zones may have a slightly higher temperature, for example, the first zone at about 80° C., the second zone at about 95° C., a third zone at about 105° C., and a final zone at about 115° C. The residence time of the former within a zone may, for instance, be about 10 minutes.

The former may then be transferred to a stripping station where the formed glove is removed from the former. The stripping station may involve automatic or manual removal of the glove 20 from the former. For example, in one embodiment, the glove 20 is manually removed from the former by turning it inside out as it is stripped from the former. After being removed from the former, the glove 20 may be rinsed in water and dried.

After the drying process, the glove is optionally inverted and halogenated. Halogenation (e.g., chlorination) may be performed in any suitable manner known to those skilled in the art. Such methods include (1) direct injection of chlorine gas into a water mixture, (2) mixing high-density bleaching powder and aluminum chloride in water, (3) brine electrolysis to produce chlorinated water, and (4) acidified bleach. Examples of such methods are described in U.S. Pat. No. 3,411,982 to Kavalir; U.S. Pat. No. 3,740,262 to Agostinelli; U.S. Pat. No. 3,992,221 to Homsy, et al.; U.S. Pat. No. 4,597,108 to Momose; and U.S. Pat. No. 4,851,266 to Momose, U.S. Pat. No. 5,792,531 to Littleton, et al., which are incorporated herein in their entirety by reference thereto for all purposes. In one embodiment, for example, chlorine gas is injected into a water stream and then fed into a chlorinator (a closed vessel) containing the glove. The concentration of chlorine may be monitored and controlled to control the degree of chlorination. The chlorine concentration is typically at least about 100 parts per million (ppm), in some embodiments from about 200 ppm to about 3500 ppm, and in some embodiments, from about 300 ppm to about 600 ppm, e.g., about 400 ppm. The time duration of the chlorination step may also be controlled to control the degree of chlorination and may range, for example, from about 1 to about 10 minutes, e.g., 4 minutes. Still within the chlorinator, the glove 20 may then be rinsed with tap water at about room temperature. This rinse cycle may be repeated as necessary. Once all water is removed, the glove 20 is tumbled to drain excess water.

The glove may contain a lubricant layer 34 as shown in FIG. 3. It should be understood that the lubricant composition may be applied at a later stage in the forming process, and may be applied using any technique, such as dipping, spraying, immersion, printing, tumbling, or the like. The coated glove is then put into a drier and dried for about 10 to 60 minutes (e.g., 40 minutes) at from about 20° C. to about 80° C. (e.g., 40° C.) to dry the inside surface of the glove. The glove is then inverted and the outside surface may be dried for about 20 to 100 minutes (e.g., 60 minutes) at from about 20° C. to about 80° C. (e.g., 40° C.).

In one embodiment, the lubricant layer may contain a silicone or silicone-based component. In some embodiments, polydimethylsiloxane and/or modified polysiloxanes may be used as the silicone component in accordance with the present invention. For instance, some suitable modified polysiloxanes that can be used in the present invention include, but are not limited to, phenyl-modified polysiloxanes, vinyl-modified polysiloxanes, methyl-modified polysiloxanes, fluoro-modified polysiloxanes, alkyl-modified polysiloxanes, alkoxy-modified polysiloxanes, amino-modified polysiloxanes, and combinations thereof.

In some embodiments, the lubricant layer may include a silicone emulsion. One such silicone emulsion that may be suitable for use with the present invention is DC 365, a pre-emulsified silicone (35 percent total solids content (TSC)) that is commercially available from the Dow Corning Corporation (Midland, Mich.). DC 365 is believed to contain 40-70 mass percent water (aqueous solvent), 30-60 mass percent methyl-modified polydimethylsiloxane (silicone), 1-5 mass percent propylene glycol (non-aqueous solvent), 1-5 mass percent polyethylene glycol sorbitan monolaurate (nonionic surfactant), and 1-5 mass percent octylphenoxy polyethoxy ethanol (nonionic surfactant). Another silicone emulsion that may be suitable for use with the present invention is SM 2140, commercially available from GE Silicones (Waterford, N.Y.). SM 2140 is a pre-emulsified silicone (50 percent TSC) that is believed to contain 30-60 mass percent water (aqueous solvent), 30-60 mass percent amino-modified polydimethylsiloxane (silicone), 1-5 percent ethoxylated nonyl phenol (nonionic surfactant), 1-5 mass percent trimethyl-4-nonyloxypolyethyleneoxy ethanol (nonionic surfactant), and minor percentages of acetaldehyde, formaldehyde, and 1,4 dioxane. Another silicone emulsion that may be suitable for use with the present invention is SM 2169 available from GE Silicones (Waterford, N.Y.). SM 2169 is a pre-emulsified silicone that is believed to contain 30-60 mass percent water, 60-80 mass percent polydimethylsiloxane, 1-5 mass percent polyoxyethylene lauryl ether, and a small amount of formaldehyde. Yet another silicone that may be suitable for use with the present invention is commercially available from GE Silicones (Waterford, N.Y.) under the trade name AF-60. AF-60 is believed to contain polydimethylsiloxane, acetylaldehyde, and small percentages of emulsifiers. If desired, these pre-emulsified silicones may be diluted with water or other solvents prior to use.

In another embodiment, the lubricant layer may contain a quaternary ammonium compound, such as that commercially available from Goldschmidt Chemical Corporation of Dublin, Ohio under the trade name VERISOFT® BTMS. VERISOFT® BTMS is believed to contain behnyl trimethyl sulfate and cetyl alcohol. Thus for example, in one embodiment, the lubricant layer includes a quaternary ammonium compound such as VERISOFT® BTMS and a silicone emulsion such as SM 2169.

In other embodiments, the lubricant layer may include, for example, a cationic surfactant (e.g., cetyl pyridinium chloride), an anionic surfactant (e.g., sodium lauryl sulfate), a nonionic surfactant, or the like.

In some embodiments, one or more cationic surfactants may be used. Examples of cationic surfactants that may be suitable for use with the present invention include, for example, behenetrimonium methosulfate, distearyldimonium chloride, dimethyl dioctadecyl ammonium chloride, cetylpyridinium chloride, methylbenzethonium chloride, hexadecylpyridinium chloride, hexadecyltrimethylammonium chloride, benzalkonium chloride, dodecylpyridinium chloride, the corresponding bromides, hydroxyethylheptadecylimidazolium halides, coco aminopropyl betaine, and coconut alkyldimethylammonium betaine. Additional cationic surfactants that may be used include methyl bis(hydrogenated tallow amidoethyl)-2-hydroxyethly ammonium methyl sulfate, methyl bis(tallowamido ethyl)-2-hydroxyethyl ammonium methyl sulfate, methyl bis(soya amidoethyl)-2-hydroxyethyl ammonium methyl sulfate, methyl bis(canola amidoethyl)-2-hydroxyethyl ammonium methyl sulfate, methyl bis(tallowamido ethyl)-2-tallow imidazolinium methyl sulfate, methyl bis(hydrogenated tallowamido ethyl)-2-hydrogenated tallow imidazolinium methyl sulfate, methyl bis(ethyl tallowate)-2-hydroxyethyl ammonium methyl sulfate, methyl bis(ethyl tallowate)-2-hydroxyethyl ammonium methyl sulfate, dihydrogenated tallow dimethyl ammonium chloride, didecyl dimethyl ammonium chloride, dioctyl dimethyl ammonium chloride, octyl decyl is dimethyl ammonium chloride diamidoamine ethoxylates, diamidoamine imidazolines, and quaternary ester salts.

In some embodiments, one or more nonionic surfactants may be used. Nonionic surfactants typically have a hydrophobic base, such as a long chain alkyl group or an alkylated aryl group, and a hydrophilic chain comprising a certain number (e.g., 1 to about 30) of ethoxy and/or propoxy moieties. Examples of some classes of nonionic surfactants that may be used include, but are not limited to, ethoxylated alkylphenols, ethoxylated and propoxylated fatty alcohols, polyethylene glycol ethers of methyl glucose, polyethylene glycol ethers of sorbitol, ethylene oxide-propylene oxide block copolymers, ethoxylated esters of fatty (C₈-C₁₈) acids, condensation products of ethylene oxide with long chain amines or amides, condensation products of ethylene oxide with alcohols, and mixtures thereof.

Specific examples of suitable nonionic surfactants include, but are not limited to, methyl gluceth-10, PEG-20 methyl glucose distearate, PEG-20 methyl glucose sesquistearate, C₁₁₋₁₅ pareth-20, ceteth-8, ceteth-12, dodoxynol-12, laureth-15, PEG-20 castor oil, polysorbate 20, steareth-20, polyoxyethylene-10 cetyl ether, polyoxyethylene-10 stearyl ether, polyoxyethylene-20 cetyl ether, polyoxyethylene-10 oleyl ether, polyoxyethylene-20 oleyl ether, an ethoxylated nonylphenol, ethoxylated octylphenol, ethoxylated dodecylphenol, or ethoxylated fatty (C₆-C₂₂) alcohol, including 3 to 20 ethylene oxide moieties, polyoxyethylene-20 isohexadecyl ether, polyoxyethylene-23 glycerol laurate, polyoxy-ethylene-20 glyceryl stearate, PPG-10 methyl glucose ether, PPG-20 methyl glucose ether, polyoxyethylene-20 sorbitan monoesters, polyoxyethylene-80 castor oil, polyoxyethylene-15 tridecyl ether, polyoxy-ethylene-6 tridecyl ether, laureth-2, laureth-3, laureth-4, PEG-3 castor oil, PEG 600 dioleate, PEG 400 dioleate, oxyethanol, 2,6,8-trimethyl-4-nonyloxypolyethylene oxyethanol; octylphenoxy polyethoxy ethanol, nonylphenoxy polyethoxy ethanol, 2,6,8-trimethyl-4-nonyloxypolyethylene alkyleneoxypolyethyleneoxyethanol, alkyleneoxypolyethyleneoxyethanol, alkyleneoxypolyethyleneoxyethanol, and mixtures thereof.

Additional nonionic surfactants that may be used include water soluble alcohol ethylene oxide condensates that are the condensation products of a secondary aliphatic alcohol containing between about 8 to about 18 carbon atoms in a straight or branched chain configuration condensed with between about 5 to about 30 moles of ethylene oxide. Such nonionic surfactants are commercially available under the trade name TERGITOL® from Union Carbide Corp. (Danbury, Conn.). Specific examples of such commercially available nonionic surfactants of the foregoing type are C₁₁-C₁₅ secondary alkanols condensed with either 9 moles of ethylene oxide (TERGITOL® 15-S-9) or 12 moles of ethylene oxide (TERGITOL® 15-S-12) marketed by Union Carbide Corp. (Danbury, Conn.).

Other suitable nonionic surfactants include the polyethylene oxide condensates of one mole of alkyl phenol containing from about 8 to 18 carbon atoms in a straight- or branched chain alkyl group with about 5 to 30 moles of ethylene oxide. Specific examples of alkyl phenol ethoxylates include nonyl condensed with about 9.5 moles of ethylene oxide per mole of nonyl phenol, dinonyl phenol condensed with about 12 moles of ethylene oxide per mole of phenol, dinonyl phenol condensed with about 15 moles of ethylene oxide per mole of phenol and diisoctylphenol condensed with about 15 moles of ethylene oxide per mole of phenol. Commercially available nonionic surfactants of this type include IGEPAL® CO-630 (a nonyl phenol ethoxylate) marketed by ISP Corp. (Wayne, N.J.). Suitable non-ionic ethoxylated octyl and nonyl phenols include those having from about 7 to about 13 ethoxy units.

In some embodiments, one or more amphoteric surfactants may be used. One class of amphoteric surfactants that may suitable for use with the present invention includes the derivatives of secondary and tertiary amines having aliphatic radicals that are straight chain or branched, where one of the aliphatic substituents contains from about 8 to 18 carbon atoms and at least one of the aliphatic substituents contains an anionic water-solubilizing group, such as a carboxy, sulfonate, or sulfate group. Some examples of amphoteric surfactants include, but are not limited to, sodium 3-(dodecylamino)propionate, sodium 3-(dodecylamino)-propane-1-sulfonate, sodium 2-(dodecylamino)ethyl sulfate, sodium 2-(dimethylamino)octadecanoate, disodium 3-(N-carboxymethyl-dodecylamino)propane-1-sulfonate, sodium 1-carboxymethyl-2-undecylimidazole, disodium octadecyliminodiacetate, and sodium N,N-bis(2-hydroxyethyl)-2-sulfato-3-dodecoxypropylamine.

Additional classes of suitable amphoteric surfactants include phosphobetaines and phosphitaines. For instance, some examples of such amphoteric surfactants include, but are not limited to, sodium coconut N-methyl taurate, sodium oleyl N-methyl taurate, sodium tall oil acid N-methyl taurate, cocodimethylcarboxymethylbetaine, lauryldimethylcarboxymethylbetaine, lauryldimethylcarboxyethylbetaine, cetyldimethylcarboxymethylbetaine, sodium palmitoyl N-methyl taurate, oleyldimethylgammacarboxypropylbetaine, lauryl-bis-(2-hydroxypropyl)-carboxyethylbetaine, di-sodium oleamide PEG-2 sulfosuccinate, laurylamido-bis-(2-hydroxyethyl) propylsultaine, lauryl-bis-(2-hydroxyethyl) carboxymethylbetaine, cocoamidodimethylpropylsultaine, stearylamidodimethylpropylsultaine, TEA oleamido PEG-2 sulfosuccinate, disodium oleamide MEA sulfosuccinate, disodium oleamide MIPA sulfosuccinate, disodium ricinoleamide MEA sulfosuccinate, disodium undecylenamide MEA sulfosuccinate, disodium wheat germamido MEA sulfosuccinate, disodium wheat germamido PEG-2 sulfosuccinate, disodium isostearamideo MEA sulfosuccinate, cocoamido propyl monosodium phosphitaine, lauric myristic amido propyl monosodium phosphitaine, cocoamido disodium 3-hydroxypropyl phosphobetaine, lauric myristic amido disodium 3-hydroxypropyl phosphobetaine, lauric myristic amido glyceryl phosphobetaine, lauric myristic amido carboxy disodium 3-hydroxypropyl phosphobetaine, cocoamphoglycinate, cocoamphocarboxyglycinate, capryloamphocarboxyglycinate, lauroamphocarboxyglycinate, lauroamphoglycinate, capryloamphocarboxypropionate, lauroamphocarboxypropionate, cocoamphopropionate, cocoamphocarboxypropionate, dihydroxyethyl tallow glycinate, and mixtures thereof.

In certain instances, one or more anionic surfactants may be used. Suitable anionic surfactants include, but are not limited to, alkyl sulfates, alkyl ether sulfates, alkyl ether sulfonates, sulfate esters of an alkylphenoxy polyoxyethylene ethanol, alpha-olefin sulfonates, beta-alkoxy alkane sulfonates, alkylauryl sulfonates, alkyl monoglyceride sulfates, alkyl monoglyceride sulfonates, alkyl carbonates, alkyl ether carboxylates, fatty acids, sulfosuccinates, sarcosinates, octoxynol or nonoxynol phosphates, taurates, fatty taurides, fatty acid amide polyoxyethylene sulfates, isethionates, or mixtures thereof.

Particular examples of some suitable anionic surfactants include, but are not limited to, C₈-C₁₈ alkyl sulfates, C₈-C₁₈ fatty acid salts, C₈-C₁₈ alkyl ether sulfates having one or two moles of ethoxylation, C₈-C₁₈ alkamine oxides, C₈-C₁₈ alkoyl sarcosinates, C₈-C₁₈ sulfoacetates, C₈-C₁₈ sulfosuccinates, C₈-C₁₈ alkyl diphenyl oxide disulfonates, C₈-C₁₈ alkyl carbonates, C₈-C₁₈ alpha-olefin sulfonates, methyl ester sulfonates, and blends thereof. The C₈-C₁₈ alkyl group may be straight chain (e.g., lauryl) or branched (e.g., 2-ethylhexyl). The cation of the anionic surfactant may be an alkali metal (e.g., sodium or potassium), ammonium, C₁-C₄ alkylammonium (e.g., mono-, di-, tri), or C₁-C₃ alkanolammonium (e.g., mono-, di-, tri).

Specific examples of such anionic surfactants include, but are not limited to, lauryl sulfates, octyl sulfates, 2-ethylhexyl sulfates, lauramine oxide, decyl sulfates, tridecyl sulfates, cocoates, lauroyl sarcosinates, lauryl sulfosuccinates, linear C₁₀ diphenyl oxide disulfonates, lauryl sulfosuccinates, lauryl ether sulfates (1 and 2 moles ethylene oxide), myristyl sulfates, oleates, stearates, tallates, ricinoleates, cetyl sulfates, and so forth.

Although various constructions and techniques for forming elastomeric articles have been described above, it should be understood that the present invention is not limited to any particular construction or technique for forming the article. For example, the layers described above may not be utilized in all instances. Additionally, other layers not specifically referred to above may be utilized in the present invention.

The present invention may be better understood with reference to the following example, which is not intended to be limiting in any manner.

### EXAMPLE

A hydrogel polymer was synthesized and prepared by ORTEC Incorporated, Easley, S.C. The hydrogel was prepared by free radical polymerization. The composition of the hydrogel polymer used was the following:

TABLE 1

| Monomer | Percent Mole Composition |
|---|---|
| Hydroxy ethyl acrylate | 54 |
| Hydroxy ethyl methacrylate | 30 |
| Acrylic acid | 16 |

The hydrogel polymer was then used in a hydrogel aqueous dipping solution with the following composition:

TABLE 2

| Ingredient | Weight Amount (grams) |
|---|---|
| Synthesized hydrogel | 2.5 |
| (formulation from Table 1) | |
| Polyacrylic acid | 0.5 |
| CYMEL ® 385 | 0.27 |
| P-toluene sulfonic acid | 0.025 |
| Water | Added to the above to obtain a |
| | total weight of 100 grams |

CYMEL® 385 was used as the crosslinking agent and was activated by the p-toluene sulfonic acid. The polyacrylic acid acted as a processing agent, giving the hydrogel aqueous dipping solution a thixotropic character with a predictable viscosity as a function of pH and former exit rate. The polyacrylic acid used was CARBOPOL® 980, available from Noveon, Inc., Cleveland, Ohio, USA.

In the range of pH (4.0 to 4.7) and hydrogel solution temperature (25 deg-30 deg C.) examined, the relation could be expressed by the equation:

$$μ = ( \frac{5636}{FER} ) * ( pH - 3.852 ) + ( 106 * pH ) - 372$$

Where:
μ=viscosity of coating solution in a pH range of 4.0 to 4.7 (centipoise)
FER=former exit rate (mm/sec)
pH=pH of the hydrogel dipping solution The hydrogel dipping solution was prepared by the formulation given in Table 2 and was found to have a pH of 3.8. The pH of the base dipping solution was adjusted with the addition of a dilute solution of sodium hydroxide. A dipping solution was prepared having a pH of 4.0 and another dipping solution was prepared having a pH of 4.7.

One set of latex gloves was dipped into the first dipping solution and another set was dipped into the second dipping solution. All dipping was conducted at a former exit rate of 29 mm/sec. At such a rate, the equation above predicts that the viscosity of the second thixotropic dipping solution (pH=4.7) will be approximately 3.6 times greater than that of the first thixotropic dipping solution (pH=4.0).

Cross-section micro-views of the treated gloves revealed that the gloves produced by the first dipping solution (pH=4.0) had a coating of about 4 microns. Gloves produced by the second dipping solution (pH=4.7) had a coating of about 10 microns.

Several of the latex gloves from both batches of dipping solutions were subjected to a water rinse and chlorination. The chlorination preformed by immersing the gloves for four minutes in an aqueous solution having 800 ppm of chlorine, produced from a mixture of bleach, hydrochloric acid and water. This was followed by a water rinse and application of the silicone emulsion. The gloves were then tumble dried.

The resulting gloves gave acceptable dry and damp hand donnability. Additionally, the hydrogel coating would not “flake off” the glove upon stretching or redissovle in water.

The desired hydrogel coating with the desired properties has been demonstrated by the inventors with a hydrogel solution that includes a hydrogel copolymer of hydroxy ethyl acrylate (HEA), hydroxy ethyl methacrylate (HEMA), and acrylic acid (AA). The aqueous solution including polyacrylic acid provides the desired rheological control with two controllable parameters: the solution has thixotropic characteristics and has a viscosity that can be altered by changing the pH of the solution.

While the invention is not limited to a single theory of operation, it is generally thought that the thixotropic nature of the solution is provided by the polyacrylic acid. There are two possible mechanisms that result in the thixotropic nature: the ability of the polyacrylic acid to from hydrogen bonds and its branched structure. The carboxylic groups of the polyacrylic acid can form hydrogen bonds with other carboxylic groups of the polyacrylic acid. These secondary bonds hold polyacrylic polymer units closer together, thus increasing the viscosity of the solution. However, these electrostatic bonds are easily broken with addition of shear forces to the solution and the viscosity will decrease upon addition of such shear forces. Once the shear is removed, these secondary bonds will reform and the viscosity will again increase.

The branched nature of the polyacrylic acid also is generally thought to contribute to the thixotropic nature of the hydrogel solution. When the solution is static or has a lower degree of shear forces applied to it, the branches are allowed to fully extend and produce a solution having a higher viscosity. However, when additional shear forces are applied to the solution, the branches of the polyacrylic acid align with the shear field and present a more streamlined geometry to the flow. The resulting viscosity is thus lowered upon application of such shear forces. When such shear forces are removed, the branches are allowed to once again spread out and the viscosity of the solution increases.

Additionally, as discussed above, the viscosity of the hydrogel solution can be controlled through control of the pH of the solution. The polyacrylic acid of the coating solution contains carboxyl acid groups which are capable of ionizing in a water solution. The increase in ionization of carboxyl acid groups, results in an increase of viscosity of the solution. Thus by controlling the pH of the dipping solution, through addition of a dilute solution of sodium hydroxide, the viscosity of the solution can be modified.

The ability to determine the response of the donning coating solution to both exit rate and pH provide unique and valuable control to the coating of elastomeric articles such as gloves. By controlling the rheology of the coating solution, the amount and quality (coverage) of coating applied can be controlled, resulting in cost savings and consistency in the end products.

A donning coating solution can be designed with a known viscosity response such that an elastomeric article can be immersed into and moved around in and through such a solution, imparting or applying shear forces at the interface of the article and the solution. The viscosity response can be such that when the elastomeric article is removed from the solution, the shear forces are eliminated at the article/solution interface and the viscosity of the solution now coating the article increases dramatically. This increase in viscosity keeps the solution coating the article from flowing on the surface of or off of the article.

By knowing the viscosity response as a function of the controllable variables of the solution, the optimal processing conditions can be determined for a particular manufacturing process. For example, the viscosity response of the hydrogel solution can be determined empirically. The viscosity of the hydrogel solution of the present invention can be measured as function of pH and as a function of rate the article exits from the solution. These empirical observations can provide a correlation of viscosity as a function of pH and exit rate. With such a correlation, the amount of coating of applied to the former by dipping in the known hydrogel solution can be known and controlled by altering the exit rate and/or the pH of the solution.

For example, a viscosity response can be found for an aqueous hydrogel solution made up of a HEA-HEMA-M hydrogel polymer (54 mole % HEA, 30 mole % HEMA, 16 mole % AA), a partially crosslinked polyacrylic acid, a crosslinking agent and an activator. For a specific range of pH (4.0 to 4.7) and solution temperature (25 deg-30 deg C.), the viscosity response can be determined and expressed by a relation such as the following:

$$μ = ( \frac{5636}{FER} ) * ( pH - 3.852 ) + ( 106 * pH ) - 372$$

Where:
μ=viscosity of coating solution in a pH range of 4.0 to 4.7 (centipoise)
FER=former exit rate (mm/sec)
pH=pH of the hydrogel dipping solution

As can be seen from this type of relationship, the pH and exit rate can be controlled in the manufacturing process to achieve the desired solution viscosity at the interface of the article and the donning coating solution. Being able to control the viscosity helps ensure that the desired amount of donning coating is applied to the surface of the article.

We claim:

1. An elastomeric article comprising:
a substrate body having a first surface, where the substrate comprises an elastomeric material; and
a hydrogel donning coating applied to at least a portion of the first surface,
where the hydrogel donning coating comprises hydroxy ethyl acrylate (HEA), hydroxy ethyl methacrylate (HEMA) and acrylic acid (AA).

2. The article of claim 1, where hydrogel donning coating comprises less than about 65 mole percent HEA.

3. The article of claim 1, where the hydrogel donning coating comprises between about 44 and about 64 mole percent HEA, about 20 and about 40 mole percent HEMA, and about 6 and about 36 mole percent AA.

4. The article of claim 1, where the hydrogel donning coating comprises between about 49 and about 59 mole percent HEA, about 25 and about 35 mole percent HEMA, and about 6 and about 26 mole percent M.

5. The article of claim 1, where the hydrogel donning coating comprises between about 53 and about 55 mole percent HEA, about 29 and about 31 mole percent HEMA, and about 14 and about 18 mole percent AA.

6. The article of claim 1, where the elastomeric material comprises natural rubber.

7. The article of claim 1, where the elastomeric material comprises a nitrile butadiene rubber.

8. The article of claim 1 where the elastomeric material comprises a styrene-ethylene-butylene-styrene block copolymer.

9. The article of claim 1, wherein the elastomeric material is selected from the group consisting of a styrene-isoprene-styrene block copolymer, styrene-butadiene-styrene block copolymer, styrene-isoprene block copolymer, styrene-butadiene block copolymer, synthetic isoprene, chloroprene rubber, polyvinyl chloride, silicone rubber, and a combination thereof.

10. The article of claim 1, further comprising a lubricant layer applied to the hydrogel donning coating.

11. The article of claim 1, where the article is a glove.

12. A method of coating an elastomeric article comprising:
preparing a substrate body comprising an elastomeric material;
immersing the substrate body in an aqueous solution of hydrogel polymer, where the aqueous solution has thixotropic properties;
removing the article from the aqueous solution; and
curing the article,
where the hydrogel solution comprises a hydrogel polymer in an aqueous solution and where the hydrogel polymer comprises hydroxy ethyl acrylate (HEA), hydroxy ethyl methacrylate (HEMA) and acrylic acid (M) and the aqueous solution comprises a crosslinking agent, a crosslinking activator, partially crosslinked polyacrylic acid and water.

13. The method of claim 12, where hydrogel polymer comprises less than about 65 mole percent HEA.

14. The method of claim 12, where the hydrogel polymer comprises between about 44 and about 64 mole percent HEA, about 20 and about 40 mole percent HEMA, and about 6 and about 36 mole percent AA.

15. The method of claim 12, where the hydrogel polymer comprises between about 49 and about 59 mole percent HEA, about 25 and about 35 mole percent HEMA, and about 6 and about 26 mole percent AA.

16. The method of claim 12, where the hydrogel polymer comprises between about 53 and about 55 mole percent HEA, about 29 and about 31 mole percent HEMA, and about 14 and about 18 mole percent AA.

17. A method of coating an elastomeric article comprising:
preparing a substrate body comprising an elastomeric material;
immersing the substrate body in a coating solution, where the coating solution has a viscosity and a viscosity response to shear forces such that the viscosity decreases in response to increasing shear forces and the viscosity increases in response to decreasing shear forces;
applying shear forces to the coating solution at the interface of the coating solution and the substrate body such that the viscosity of the coating solution decreases at the interface;
removing the shear forces from the substrate body covered with coating solution such that viscosity of the coating solution increases while on the substrate body.
